(19) United States
(12) Patent Application Publication
(10) Pub. No.: US 2013/0054986 A1
(43) Pub. Date: Feb. 28, 2013

(54) METHOD AND APPARATUS FOR BOOTING ELECTRONIC DEVICE BASED ON USE CONTEXT

(71) Applicants: Ki-Beom KIM, Seoul (KR); Rakie KIM, Suwon-si (KR)

(72) Inventors: Ki-Beom KIM, Seoul (KR); Rakie KIM, Suwon-si (KR)

(73) Assignee: Samsung Electronics Co., Ltd.

(21) Appl. No.: 13/594,453

(22) Filed: Aug. 24, 2012

(30) Foreign Application Priority Data
Aug. 25, 2011 (KR) 10-2011-0084382

(51) Int. Cl. G06F 1/26

(52) U.S. Cl. 713/300

(57) ABSTRACT

A method and apparatus for booting an electronic device are provided. The method includes collecting context information regarding the electronic device; determining whether a use of the electronic device is expected based on the collected context information; and when the use of the electronic device is expected, supplying electric power to at least one of predetermined elements of the electronic device.

### PRIORITY

This application claims priority under 35 U.S.C. §119(a) to a Korean Patent Application filed in the Korean Intellectual Property Office on Aug. 24, 2011 and assigned Serial No. 10-2011-0084382, the entire disclosure of which is incorporated herein by reference.

### BACKGROUND OF THE INVENTION

1. Field of the Invention

The present invention relates generally to high-speed booting technology for electronic devices and, more particularly, to a booting method and apparatus in which a part of the elements of an electronic device are supplied with power and are activated before the power button is selected.

2. Description of the Related Art

Most modern electronic information and communications devices, such as digital cameras, navigation devices, or notebook computers, have an embedded system. Unfortunately, the embedded system may boot for a long time. A reduction in boot time is an issue to be solved in many electronic devices.

A conventional approach to reducing the boot time is to continuously supply electric power to elements of the electronic device even after a user selects a power-off button. This may, however, cause excessive power consumption since the supply of power is continuously supplied without considering the use pattern of the device. Therefore, a new approach that allows high-speed booting with the minimum power consumption is needed.

Another conventional approach to reducing boot time is to require an electronic device to be automatically operated in a low power mode such as a sleep mode. This approach considers the use pattern of a device in order to reduce power consumption. However, this approach considers limited context information, while aiming only at reduced power consumption. Thus, this approach may not be effectively applied to a low boot time. Therefore, a new technique is needed to realize a high-speed booting based on context information analyzed in various aspects.

### SUMMARY OF THE INVENTION

Accordingly, the present invention has been made to solve the above-stated problems occurring in the prior art and to offer at least the advantages described below.

An aspect of the present invention is to provide an electronic device booting method and apparatus realizing a high-speed booting with lowest power consumption.

Another aspect of the present invention is to provide an electronic device booting method and apparatus allowing a user to freely define a boot standby condition.

According to one aspect of the present invention, a method for booting an electronic device is provided, the method including collecting context information regarding the electronic device; determining whether a use of the electronic device is expected based on the collected context information; and when the use of the electronic device is expected, supplying electric power to at least one of predetermined elements of the electronic device.

According to another aspect of the present invention, an apparatus for booting an electronic device is provided, the apparatus including a sensing unit for sensing context information about the electronic device; a boot control unit for receiving the context information from the sensing unit, determining whether the use of the electronic device is expected, and when the use of the electronic device is expected, sending a control signal to increase a boot speed; and a power control unit for receiving the control signal acting as a trigger of operation from the boot control unit, and supplying electric power to at least one of predetermined elements of the electronic device.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating the configuration of a booting apparatus for an electronic device in accordance with an embodiment of the present invention.

FIG. 2 is a flowchart illustrating a process of booting an electronic device in accordance with an embodiment of the present invention.

FIG. 3 is a flowchart illustrating a booting process based on a use time in accordance with an embodiment of the present invention.

FIG. 4 is a flowchart illustrating a booting process based on a touch on or movement of an electronic device in accordance with an embodiment of the present invention.

### DETAILED DESCRIPTION OF EMBODIMENTS OF THE PRESENT INVENTION

Hereinafter, embodiments of the present invention will be described with reference to the accompanying drawings. This invention may, however, be embodied in many different forms and should not be construed as limited to the embodiments set forth herein. Rather, the disclosed embodiments are provided so that this disclosure will be thorough and complete, and will fully convey the scope of the invention to those skilled in the art. The principles and features of this invention may be employed in various and numerous embodiments without departing from the scope of the invention.

Furthermore, well known or widely used techniques, elements, structures, and processes may not be described or illustrated in detail so as to avoid obscuring the essence of the present invention. Although the drawings represent embodiments of the invention, the drawings are not necessarily to scale and certain features may be exaggerated or omitted in order to better illustrate and explain the present invention.

Among the terms set forth herein, a “boot standby state” refers to a state in which electric power is supplied to a part of the elements of an electronic device and thereby such elements are activated before a power button is selected. The elements activated in advance may include at least one of Random Access Memory (RAM), Central Processing Unit (CPU), and Read-Only Memory ROM. Additionally, a “boot standby condition” refers to particular cases of forcing an electronic device to be in boot standby state. A user may determine boot standby condition.

Electronic devices to which the present invention can be applied include navigation devices, notebook computers, digital cameras, and any other devices requiring a high-speed boot process. In this electronic device, elements that enter into boot standby state are not limited to RAM, and the like. In special cases, at least one CPU or any input device such as a touch screen may also be in boot standby state. Furthermore, the CPU, ROM and RAM may be in boot standby state.

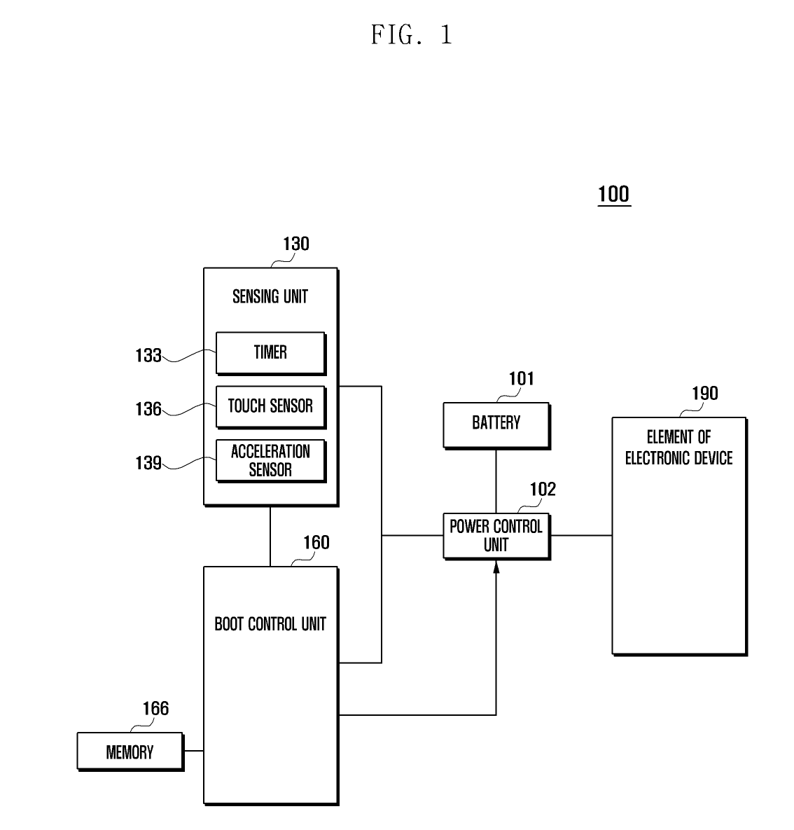

FIG. 1 is a block diagram illustrating the configuration of a booting apparatus for an electronic device in accordance with an embodiment of the present invention. As shown in FIG. 1, the booting apparatus 100 includes a sensing unit 130, a boot control unit 160, a power control unit 102, and at least one predetermined element 190, such as RAM, of the electronic device.

The sensing unit 130 performs a function of sensing the use context information of the electronic device. The sensing unit 130 may include at least one of a timer 133, a touch sensor 136, and an acceleration sensor 139. The sensing unit 130 senses use context information and sends sensing signals to the boot control unit 160. Specifically, the timer 133 performs the function of sensing the current time. The touch sensor 136 is not a normal input unit typically used in a touch screen. The touch sensor 136 is installed externally on the electronic device and performs the function of sensing a user's touch of the device. The acceleration sensor 139 performs the function of sensing a movement of the device.

The boot control unit 160 receives sensing signals from the sensing unit 130 and determines whether the use of the device is expected. If the device is expected to be used, the boot control unit 160 sends a signal to the power control unit 102 so that electric power is supplied to the predetermined element 190 to be activated. Namely, the electronic device enters into boot standby state with specific functions activated and is ready to receive the selection of a power button. Moreover, when the power button is not selected within a given time in boot standby state, the boot control unit 160 may send a signal to the power control unit 102 to stop the supply of power.

The sensing unit 130 and the boot control unit 160 receive power from a battery 101 even after a power-off button is selected. The boot control unit 160 may have or be connected to a memory 166 that stores data required for its processing. The memory 166 may store data regarding a boot standby condition input by a user, data regarding estimated use time range, data regarding the element 190 to receive the power, and the like.

In the case of a digital camera, the power control unit 102 supplies the power of the battery 101 to both the touch sensor 136 and the boot control unit 160 even after a power-off button is selected. Namely, even though the digital camera is turned “off,” both the touch sensor 136 and the boot control unit 160 remain activated. If a user touches the turned off camera, the touch sensor 136 detects a user's touch and sends a touch signal to the boot control unit 160. The boot control unit 160 then determines that the camera is expected to be used, and sends a signal in instruct the supply of power to the power control unit 102. The power control unit 102 then supplies the power of the battery 101 to the element 190 of the camera, e.g., an image-sensing module. Further, while the image-sensing module is in boot standby state, the camera is ready to receive the selection of a power button.

A user may input a boot standby condition that the touch sensor is required to receive, for example, for three seconds or longer touch input, For example, the user can input the number of seconds.

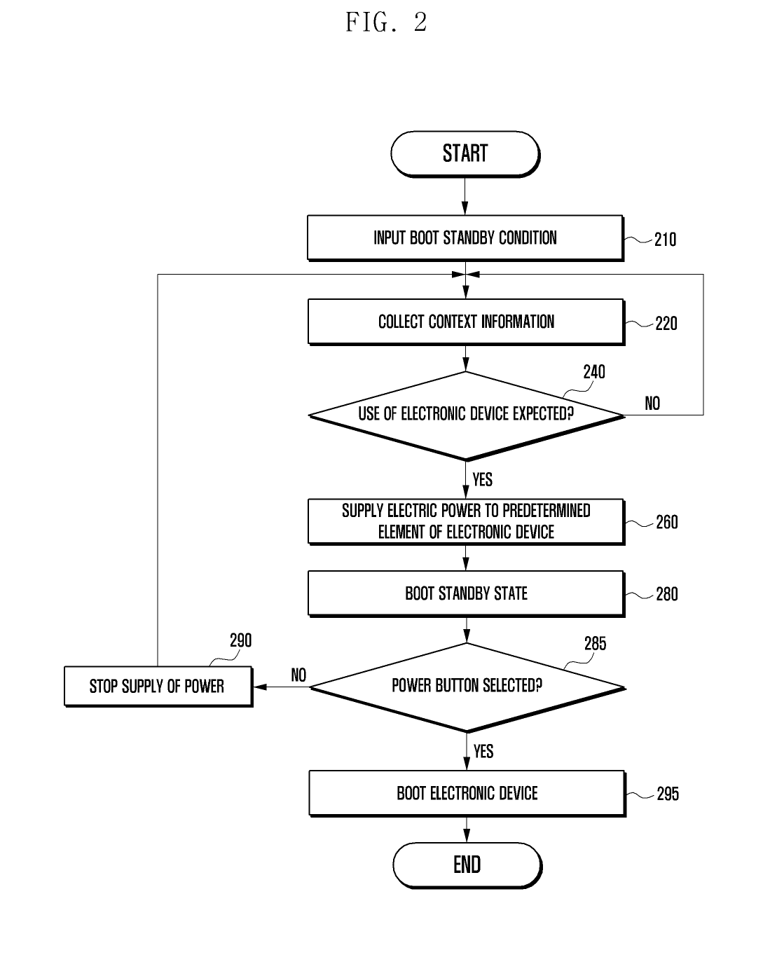

Normally, boot standby condition may be input through an input unit of the device when the digital camera is turned on. The input condition is then stored in the memory 166 and will be considered for determination of the boot control unit 160. If the touch sensor 136 sends a signal for three seconds or more, the boot control unit 160 may determine that the turned-off camera is expected to be used. Related embodiments will now be described in detail with reference to FIGS. 2 to 4.

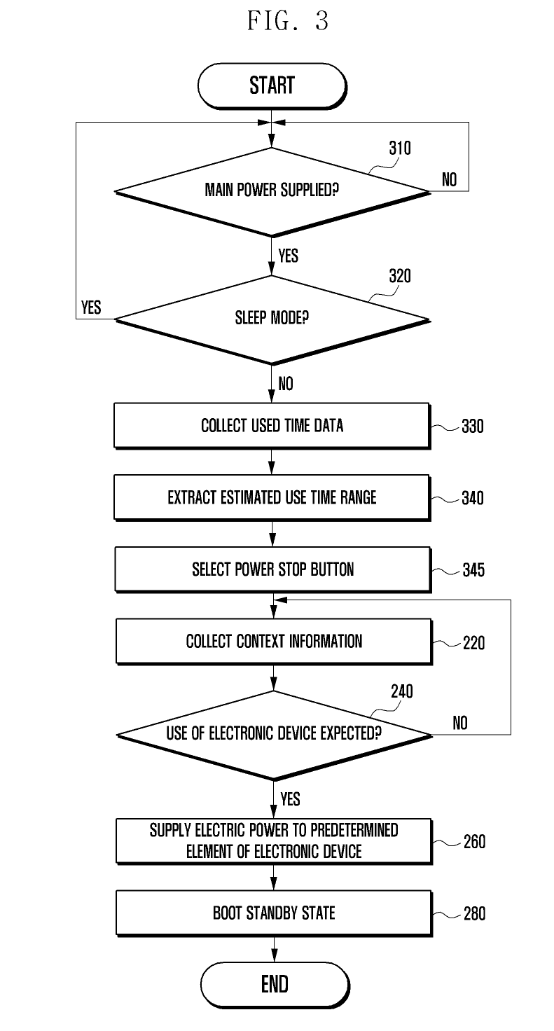

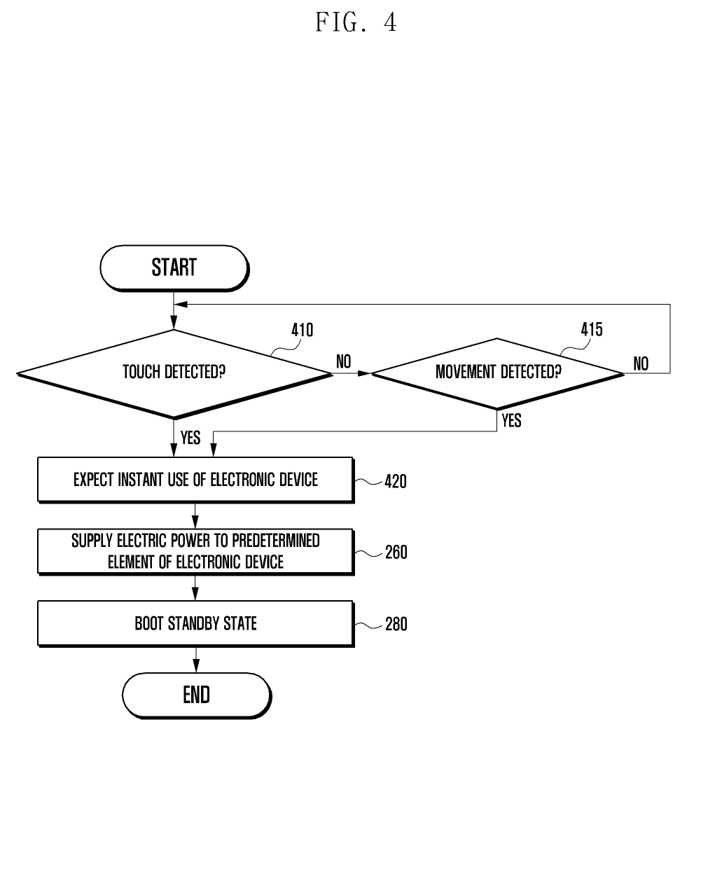

FIG. 2 is a flowchart illustrating a process of booting an electronic device in accordance with an embodiment of the present invention. The following discussion about the process shown in FIG. 2 will also refer to FIGS. 3 and 4 that show embodiments of collecting use context information. These embodiments will be fully described again after the discussion of FIG. 2. Steps 210, 285, 290 and 295 of FIG. 2 may be omitted in some embodiments.

The boot process, especially including step 210, in FIG. 2, is includes a step of receiving boot standby condition from a user. Repeated steps to be described later will be omitted.

A user may not desire that the electronic device enters into boot standby state. Also, aside from use context information, a user may desire that the electronic device enters into boot standby state in particular cases. Step 210 considers such cases. Although step 210 is performed before step 220 in FIG. 2, this is merely illustrative. Step 210 may be performed after step 220 only if steps 210 and 220 are performed before step 240.

In the first embodiment, to be discussed below, the navigation device may automatically enter into boot standby state from 9 a.m. to 11 a.m. on weekends. However, a user may further desire, for example, that the navigation device is also in boot standby state from 8 a.m. to 8:10 a.m. on weekdays. A user may directly input the desired conditions through an input unit of the navigation device so that the device may be in boot standby state from 8:00 to 8:10 a.m. on weekdays as well as from 9:00 to 11:00 a.m. on weekends. Specifically, when a user inputs 8:00 to 8:10 a.m. of weekdays as boot standby condition in step 210, the input data is stored in the memory 166 connected to the boot control unit 160. Aside from this, use time data is collected. Thereafter, in step 240, based on a signal of the timer 133, the boot control unit 160 may determine that the navigation device is expected to be used from 8:00 to 8:10 a.m. on weekdays and from 9:00 to 11:00 a.m. on weekends.

In the second embodiment to be discussed below, a notebook computer may enter into boot standby state as soon as a user's touch occurs. However, a user may desire that the notebook computer be in boot standby state only if a touch continues for a given period of time. A user may directly input desired conditions through an input unit of the notebook computer so that the device may be in boot standby state when the touch sensor continuously senses a touch for a given time, e.g., three seconds. Specifically, when a user inputs a touch of three seconds as boot standby condition in step 210, the input data is stored in the memory 166 connected to the boot control unit 160. Next, in step 220, the touch sensor 136 detects a user's touch of the notebook computer. Thereafter, in step 240, when a touch of three seconds is detected, the boot control unit 160 may determine that the notebook computer is expected to be used.

In the second embodiment, discussed below, the digital camera may enter into boot standby state when movement is detected. However, a user may not desire this. A user may input desired conditions so that the digital camera is not in boot standby state regardless of movement. Specifically, when a user inputs a no use of boot standby condition in step 210, the input data is stored in the memory 166 connected to the boot control unit 160. Therefore, even though the movement of the digital camera is detected in step 220, the boot control unit 160 may not determine in step 240 that the notebook computer is expected to be used.

In another embodiment, a booting process may be performed without step 210. Namely, in this case, there is no boot standby condition. In step 220, the boot control unit 160 collects use context information from signals received from the sensing unit 130. The use context information may include a use time of the electronic device, a touch of the electronic device, and a movement of the electronic device. An embodiment for collecting context information based on a use time will be described with reference to FIG. 3. An embodiment for collecting context information based on a touch and movement of the electronic device will be described with reference to FIG. 4. These embodiments are, however, merely illustrative and not to be considered as limiting the invention.

After context information is collected in step 220, the boot control unit 160 determines, on the basis of collected context information in step 240, whether the use of the electronic device is expected. For example, if a collected use time is mainly from 9:00 to 10:00 p.m., the boot control unit 160 receives a signal from the timer 133 and determines whether the current time is in the collected use time.

If the use of the electronic device is expected, the boot control unit 160 sends a signal to the power control unit 102 in step 260 so that the power control unit 102 supplies the electric power to the predetermined element 190, especially RAM, ROM or CPU. Therefore, the element 190 is activated and then enters into boot standby state in step 280. Thereafter, when a user selects a power button, a booting process is performed rapidly because of the activated element. This relates to steps following step 285, which will be described hereinafter.

A booting process including steps 285, 290 and 295, form another embodiment of this invention. In this embodiment, when the power button is not selected within a given time after the power is supplied to the element, the supply of power is automatically stopped.

The electronic device expected to be used may not actually be used. Thus, keeping the electronic device in boot standby state is undesirable due to needless power consumption. Therefore, when the power button is not selected in boot standby state, the booting apparatus 100 may stop the supply of power. Time to wait for the selection of the power button may be defined by a user or supplier in consideration for properties of the electronic device. This data is stored in the memory 166.

Specifically, in step 285, the boot control unit 160 determines whether the power button is selected within a given time. If so, the electronic device is booted in step 295 and the entire process flow is ended. However, if not so, the boot control unit 160 sends a signal to stop the supply of power to the power control unit 102 in step 290. Therefore, if a given time elapses in boot standby state, the booting apparatus 100 stops the supply of power. For example, if the time to wait for the selection of the power button is established as three minutes in the digital camera, the supply of power is stopped after the digital camera remains in boot standby state for three minutes.

Methods for collecting the context information will now be described in detail in reference to two embodiments.

### First Embodiment

FIG. 3 illustrates the first embodiment, in which the context information is collected on the basis of a use time. In the navigation device for example, use time data may be collected depending on the time during when main power is supplied. Since most current electronic devices employ a sleep mode in the case of non-use, time in sleep mode may be excluded. Namely, by excluding time when the device is in the sleep mode in step 320 from time when main power is supplied in step 310, use time data is collected in step 330. Based on this data, the CPU of the navigation device extracts estimated use time range data in step 340. This estimated data is stored in the memory 166 connected to the boot control unit 160. Even though the power-off button is selected in step 345, the boot control unit 160, which receives the supply of power, can utilize such data.

Supposing that a time of a weekend from 9 to 11 a.m. is extracted as the estimated use time range data for the navigation device. The timer 133 then generates a signal indicating the current time in step 220. Then, in step 240, the boot control unit 160 determines that the use of the navigation device is expected when the current time is in the estimated use time range stored in the memory 166. Thereafter, in step 260, the boot control unit 160 sends a signal to the power control unit 102 so that the power control unit 102 supplies the electric power to both a GPS module equipped in the navigation device and RAM into which location data is input. Moreover, in step 280, the navigation device enters into boot standby state that waits for the selection of the power button. When a user selects the power button, the navigation device is already sending GPS signals. Thus, the navigation device can be immediately operated as soon as an electronic map application is provided to CPU. Namely, a high-speed booting process Occurs.

### Second Embodiment

FIG. 4 shows the second embodiment, in which the context information is collected on the basis of a touch on or movement of an electronic device. According to embodiments of the present invention, one of steps 410 and 415 may be omitted or both may be performed. Namely, in some embodiments, the context information may be collected using both the touch sensor 136 and the acceleration sensor 139. In the digital camera for example, the context information may be collected through both the touch sensor 136 and the acceleration sensor 139. Even though any touch is not detected from the digital camera, the boot control unit 160 may expect an instant use of the digital camera in step 420 when any movement of the digital camera is detected.

Specifically, the touch sensor 136 senses a user's touch of the digital camera, and the acceleration sensor 139 senses a movement of the digital camera. The touch sensor 136 or the acceleration sensor 139 may be installed externally on a body of the digital camera and operate by receiving the supply of power even when the digital camera is turned off. Touching or moving the turned-off digital camera is normally considered as a user's intention of using the digital camera. It is therefore expected to instantly use the digital camera. In step 410, the touch sensor 136 senses whether a user touches the digital camera. If a touch is detected, step 420 is performed. If no touch is detected, the acceleration sensor 139 senses in step 415 whether a user moves the digital camera. If a movement is detected, step 420 is performed. Steps 410 and 415 are repeated until any touch or movement is detected. If a touch or movement is detected, the touch sensor 136 or the acceleration sensor 139 sends a sensing signal to the boot control unit 160. Then, in step 420, the boot control unit 160 determines that the digital camera will be instantly used. Thereafter, in step 260, the boot control unit 160 sends a signal to the power control unit 102 so that the power control unit 102 supplies the electric power to both an image-sensing module equipped in the digital camera and nonvolatile RAM in which image capture process data is stored. Furthermore, in step 280, the digital camera enters into boot standby state that waits for the selection of the power button. When a user selects the power button, the image-sensing module is already activated. Therefore, the digital camera can immediately be ready to capture images as soon as the process data is provided to CPU. Namely, a high-speed boot process is realized.

As mentioned above, one of steps 410 and 415 may be omitted in some embodiments. Namely, the booting process may be performed using one of a touch of and movement of the electronic device as the context information. For example, the notebook computer may be provided with the touch sensor 136 without having the acceleration sensor 139. In this case, the context information may be collected through the touch sensor 136 alone. To touch the turned-off notebook computer, for example, to open the notebook computer, is normally considered as a user's intention of using the notebook computer. It is therefore expected to instantly use the notebook computer.

Specifically, in step 410, the touch sensor 136 senses whether a user touches the notebook computer and, if so, sends a signal to the boot control unit 160. Then, in step 420, the boot control unit 160 determines that the notebook computer will be instantly used. Thereafter, in step 260, the boot control unit 160 sends a signal to the power control unit 102 so that the power control unit 102 supplies the electric power to nonvolatile RAM in which operating system data is stored. Also, in step 280, the notebook computer enters into boot standby state that waits for the selection of the power button. When a user selects the power button, the operating system data is already loaded on RAM and therefore the notebook computer can rapidly access the entire hard disk. Namely, a high-speed booting process is realized.

As discussed above, the present invention can collect user context information, determine whether the user of the electronic device is expected, and supply electric power to predetermined elements of the electronic device in order to increase a booting speed. Moreover, a user can freely define a boot standby condition.

While the present invention has been particularly shown and described with reference to embodiments thereof, it will be understood by those skilled in the art that various changes in form and details may be made therein without departing from the spirit and scope of the invention as defined by the appended claims and their equivalents.

What is claimed is:

1. A method for booting an electronic device, the method comprising steps of:
collecting context information regarding the electronic device;
determining whether a use of the electronic device is expected based on the collected context information; and
when the use of the electronic device is expected, supplying electric power to at least one of predetermined elements of the electronic device.

2. The method of claim 1, wherein collecting context information includes at least one of
generating current time information through a timer;
sensing a touch of the electronic device through a touch sensor; and
sensing a movement of the electronic device through an acceleration sensor.

3. The method of claim 2, further comprising:
collecting use time data and then extracting estimated use time range on the basis of the use time data, before the collecting context information,
wherein the determining includes determining that the use of the electronic device is expected when the current time is included in the estimated use time range.

4. The method of claim 2, wherein determining whether use of the electronic device is expected includes determining that the use of the electronic device is expected when the touch of the electronic device is sensed.

5. The method of claim 2, wherein determining whether use of the electronic device is expected includes determining that the use of the electronic device is expected when the movement of the electronic device is sensed.

6. The method of claim 1, further comprising:
stopping the supply of electric power when a power button is not selected within a predetermined time after the supplying electric power.

7. The method of claim 1, further comprising:
receiving a boot standby condition input by a user before determining whether the use of the electronic device is expected,
wherein determining whether use of the electronic device is expected is performed according to the boot standby condition.

8. An apparatus for booting an electronic device, the apparatus comprising:
a sensing unit for sensing context information about the electronic device;
a boot control unit for receiving the context information from the sensing unit, determining whether the use of the electronic device is expected, and when the use of the electronic device is expected, sending a control signal to increase a boot speed; and
a power control unit for receiving the control signal acting as a trigger of operation from the boot control unit, and supplying electric power to at least one of predetermined elements of the electronic device.

9. The apparatus of claim 8, wherein the sensing unit includes at least one of
a timer for generating current time information;
a touch sensor for sensing a touch of the electronic device; and
an acceleration sensor for sensing a movement of the electronic device.

10. The apparatus of claim 9, wherein the boot control unit further comprises:
receiving a signal regarding the current time from the timer;
determining whether the current time is included in an estimated use time range;
determining that the use of the electronic device is expected when the current time is included in the estimated use time range.

11. The apparatus of claim 9, wherein the boot control unit further comprises:
determining that the use of the electronic device is expected when receiving a signal regarding the touch of the electronic device from the touch sensor.

12. The apparatus of claim 9, wherein the boot control unit further comprises:
determining that the use of the electronic device is expected when a signal regarding the movement of the electronic device is received from the acceleration sensor.

13. The apparatus of claim 8, wherein the boot control unit further comprises:
sending a signal to stop the supply of electric power to the power control unit when a power button is not selected within a predetermined time after the electric power is supplied to the elements of the electronic device.

14. The apparatus of claim 8, wherein the boot control unit is further configured to determine whether the use of the electronic device is expected, by considering a boot standby condition input by a user.
